(19) United States
(12) Patent Application Publication
(10) Pub. No.: US 2006/0146166 A1
(43) Pub. Date: Jul. 6, 2006

(54) Digital camera and electronic device

(76) Inventors: Tatsuro Abe, Ome-shi (JP); Toyokazu Aizawa, Sagamihara-shi (JP)

Correspondence Address: DLA PIPER RUDNICK GRAY CARY US LLP, P. O. BOX 9271, RESTON, VA, 20195, US

(21) Appl. No.: 11/220,877

(22) Filed: Sep. 6, 2005

(30) Foreign Application Priority Data
Jan. 5, 2005 (JP) 2005-000840

(51) Int. Cl. H04N 5/222

(52) U.S. Cl. 348/333.01

(57) ABSTRACT

An electronic device includes a display unit configured to align and display a plurality of selection candidates on an arc, and identify and display a selection target of the plurality of selection candidates. A rotary member is arranged almost concentrically with the arc. An identification display control unit is configured to control a change of the selection target along the plurality of selection candidates aligned on the arc on the basis of rotation of the rotary member.

### CROSS-REFERENCE TO RELATED APPLICATIONS

This application is based upon and claims the benefit of priority from Japanese Patent Application No. 2005-000840, filed Jan. 5, 2005, the entire contents of which are incorporated herein by reference.

### BACKGROUND OF THE INVENTION

1. Field of the Invention

The present invention relates to an electronic device such as a video photographic device (digital camera) for photographing still and moving images.

2. Description of the Related Art

In recent years, multi-functional digital devices such as video photographic devices have become prevalant. Since such digital devices implement multiple functions, their operations are sometimes complicated. In order to easily perform these complex operations, Jpn. Pat. Appln. KOKAI Publication No. 2002-290795 proposes several variations concerning the operation of a cross key.

The cross key is used to select items in a vertical direction in addition to a horizontal direction. Accordingly, one key called a “cross key” can relatively easily select many items.

However, the multifunctionality of digital devices continues to be enhanced, and demand has arisen for further improving their operability.

### BRIEF SUMMARY OF THE INVENTION

According to an aspect of the present invention, there is provided a digital camera comprising a photographic unit configured to photograph a video, a recording unit configured to record the video photographed by the photographic unit, a display unit configured to: 1) display the video photographed by the photographic unit, 2) align and display a plurality of selection candidates on an arc in response to a display switching operation, and 3) identify and display a selection target of the plurality of selection candidates, a rotary member arranged substantially concentrically with the arc, and an identification display control unit configured to control a change of the selection target among the plurality of selection candidates aligned on the arc on the basis of rotation of the rotary member.

According to an aspect of the present invention, there is provided an electronic device comprising a display unit configured to: 1) to align and display a plurality of selection candidates on an arc, and 2) identify and display a selection target of the plurality of selection candidates, a rotary member arranged substantially concentrically with the arc, and an identification display control unit configured to control a change of the selection target among the plurality of selection candidates aligned on the arc on the basis of rotation of the rotary member.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an example of a video photographic device of the present invention;

FIG. 2 is a view showing a video displayed on a display unit in the video photographic device shown in FIG. 1;

FIG. 3 is a view for explaining an example of a jog dial and a determination button in the video photographic device shown in FIGS. 1 and 2;

FIG. 4 is a functional block diagram for explaining an example of the main function of the video photographic device shown in FIGS. 1 to 3;

FIG. 5 is a view showing an example of the positional relationship between the jog dial and an arc on which icons are aligned on a menu screen;

FIG. 6 is a view showing a first example of the relationship between the rotating operation of the jog dial and a transition on the menu screen;

FIG. 7 is a view showing a second example of the relationship between the rotating operation of the jog dial and the transition on the menu screen;

FIG. 8 is a view showing a third example of the relationship between the rotating operation of the jog dial and the transition on the menu screen;

FIG. 9 is a view showing a fourth example of the relationship between the rotating operation of the jog dial and the transition on the menu screen;

FIG. 10 is a view showing an example of a cyclic display of selection candidates; and

FIG. 11 is a view showing an example of a setting changeable display using the jog dial.

### DETAILED DESCRIPTION OF SEVERAL EMBODIMENTS

An embodiment of the present invention will be described below with reference to the accompanying drawing.

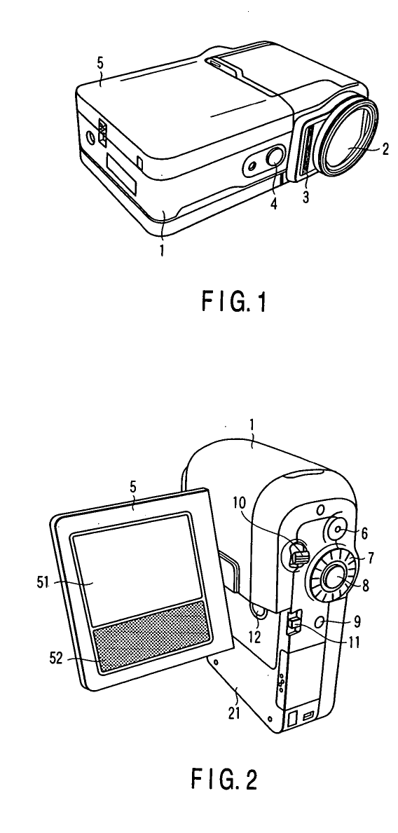

FIGS. 1 and 2 are views showing an example of a video photographic device (digital camera) of the present invention. FIG. 1 is a view showing a display unit housed in a housing unit arranged in the main body of the video photographic device. FIG. 2 is a view showing a video on the display unit.

As shown in FIGS. 1 and 2, the video photographic device has a main body 1. The main body 1 includes a lens 2, flash 3, shutter button 4, display unit 5, moving image recording button 6, jog dial (rotary member) 7, determination button 8, menu button 9, zoom bar 10, mode lever 11, power button 12, and the like.

The main body 1 also includes a housing portion 21 in which the display unit 5 can be housed. The display unit 5 is movable so that the display unit 5 can be opened from the housing portion 21, and the angle of a display surface can be arbitrarily adjusted. The display unit 5 includes an LCD (Liquid Crystal Display) 51 and loudspeaker 52.

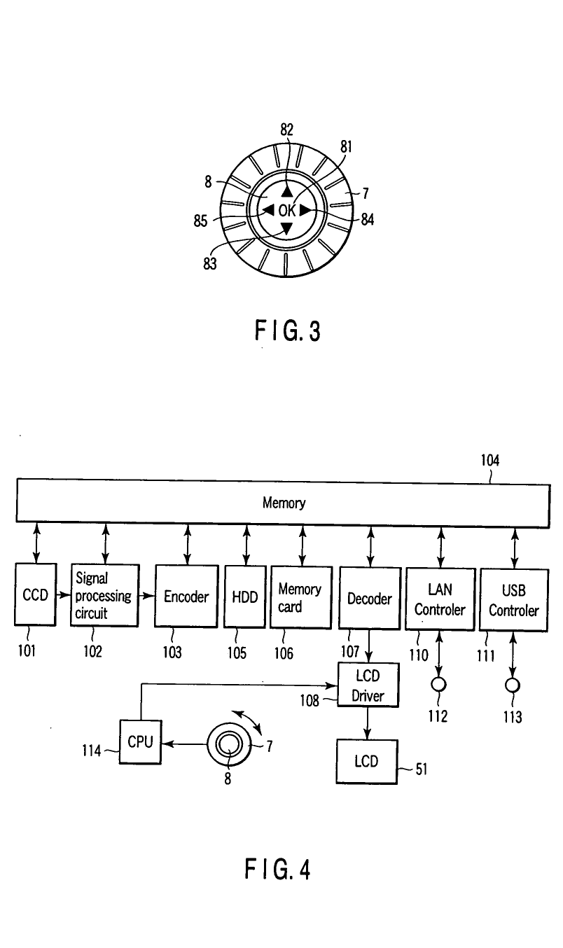

FIG. 3 is a view for explaining the jog dial and the determination button in detail.

As shown in FIG. 3, the jog dial 7 has a ring shape. The jog dial 7 can be rotated clockwise and counterclockwise. Note that the shape of the jog dial 7 is not limited to a ring shape. The jog dial 7 may have a polygonal ring shape such that a finger can easily catch the jog dial.

The circular determination button 8 is arranged in the jog dial 7. The determination button 8 has a determination key 81 at the center position, an UP key 82 at the upper position, a DOWN key 83 at the lower position, a RIGHT key 84 at the right position, and a LEFT key 85 at the left position.

FIG. 4 is a block diagram showing the schematic arrangement of the video photographic device explained with reference to FIGS. 1 to 3.

As shown in FIG. 4, the video photographic device includes a CCD 101, a signal processing circuit 102, an encoder 103, a memory 104, an HDD 105, a memory card 106, a decoder 107, an LCD driver 108, the LCD 51, a LAN controller 110, a USB controller 111, a LAN terminal 112, a USB terminal 113, a CPU 114, and the like.

In response to the operation of the shutter button 4, the CCD 101 converts light (still image) obtained via the lens 2 into an electrical signal. Alternatively, in response to the operation of the moving image recording button 6, the CCD 101 converts light (moving image) obtained via the lens 2 into an electrical signal. The signal processing circuit 102 converts the electrical signal output from the CCD 101 into a digital signal. The encoder 103 encodes the still image digital signal into a JPEG image signal. The encoder 103 also encodes the moving image digital signal into an MPEG image signal. The HDD 105 stores the image signal supplied via the memory 104. Similarly, the detachable memory card 106 stores the image signal supplied via the memory 104. The decoder 107 decodes the image signal supplied via the memory. The LCD driver 108 controls driving of the LCD 51 on the basis of the decoded image signal, and outputs the image signal on the liquid crystal display.

When playing back the recorded image, the decoder 107 decodes the image signal supplied from the HDD 105 or the memory card 106 via the memory 104. The LCD driver 108 controls to drive the LCD 51 on the basis of the decoded image signal, and outputs the image signal on the LCD 51.

When the image recorded in the HDD 105 or the memory card 106 is transferred to an external device (e.g., PC), or when the image is received from the external device, the image is transmitted/received from the USB terminal 113 via the USB controller 111. For example, the encoded image can also be directly transmitted/received to/from the image recording/playback device such as a DVD recorder without using an external device such as a PC.

Generally, when the image is transferred to the DVD recorder, the encoded moving image is decoded on a transmitting side (video photographic device side). The analog signal is then output from a video terminal or an S terminal, and re-encoded and stored on the receiving side (video recording/playback device side). In this method, for example, it takes 1 hr to record the image which was recorded in 1 hr, on the DVD or the like.

However, in this video photographic device, as described above, the encoded image can be transferred to the image recording/playback device via a network as streaming data. Hence, although it depends on the compression ratio in encoding, a transfer time can be 1/10 or less the real recording time. Additionally, since the image is not re-encoded, a high image quality can be maintained. For example, when the transfer time is about 1/10 the real recording time, it takes only about 6 min to record the moving image which was recorded in 1 hr, on another recording medium. When a LAN is used as the network, the image data is transmitted/received using the LAN terminal 112 via the LAN controller 110. Note that the data to be transferred is not limited to moving images and still images. The data may be audio data.

The video photographic device includes the HDD 105 serving as a large-capacity storage device. That is, the HDD 105 can store various data (an enormous number of still images or a long moving image). Along with this, the operation of forwarding/rewinding the image is required to be fast. Hence, in order to perform these operations in a user friendly fashion, the jog dial 7 and the determination button 8 are used. Upon rotation of the jog dial 7, the jog dial 7 outputs information about a rotational amount (rotational angle) and a rotational direction, to the CPU 114 which controls the entire system. For example, the jog dial 7 outputs a pulse in accordance with a given rotational angle. When the jog dial 7 is rotated n°, the jog dial 7 outputs one pulse. The CPU 114 checks a pulse count per unit time, and calculates the rotational angle (rotational speed) per unit time. As described above, the CPU 114 obtains rotational information such as the rotational amount (rotational angle), rotational direction, and rotational speed of the jog dial 7. On the basis of this rotational information, the display on the LCD 51 is controlled. The determination button 8 notifies the CPU 114 of depression of the determination key 81 at the center position, the UP key 82 at the upper position, the DOWN key 83 at the lower position, the RIGHT key 84 at the right position, and the LEFT key 85 at the left position. On the basis of depressions of the respective keys of the determination button 8, the CPU 114 controls various operations, and also controls the display on the LCD 51.

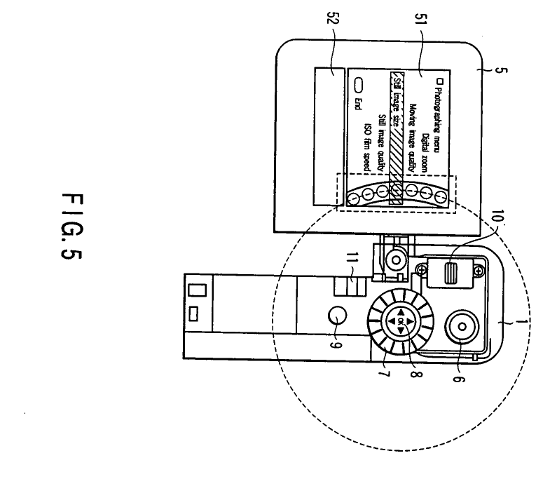

With reference to FIGS. 5 to 11, the layout of the jog dial 7, and a display state transition on the LCD 51 upon rotation of the jog dial 7 will be described below.

As shown in FIG. 5, when the display unit 5 is set at a predetermined position (when the LCD 51 is opened and set at a predetermined position), menu icons can be displayed almost concentrically with the jog dial 7, on the LCD 51.

When the menu button 9 is operated when the video photographic device is powered on, for example, the menu screen shown in FIG. 5 is displayed. On this menu screen, a plurality of selection candidates are displayed as icons and aligned on an arc. On the menu screen, only one selection target (selected icon) of the plurality of selection candidates is identified and displayed by a cursor or the like. The jog dial 7 is arranged visually almost concentrically with the arc on the menu screen.

On the basis of the rotational information such as the rotational amount (rotational angle), rotational direction, and rotational speed of the jog dial 7, the CPU 114 controls the change of the selection target by the cursor or the like, along the arc on which the plurality of selection candidates are aligned. That is, the CPU 114 serves as an identification display control unit.

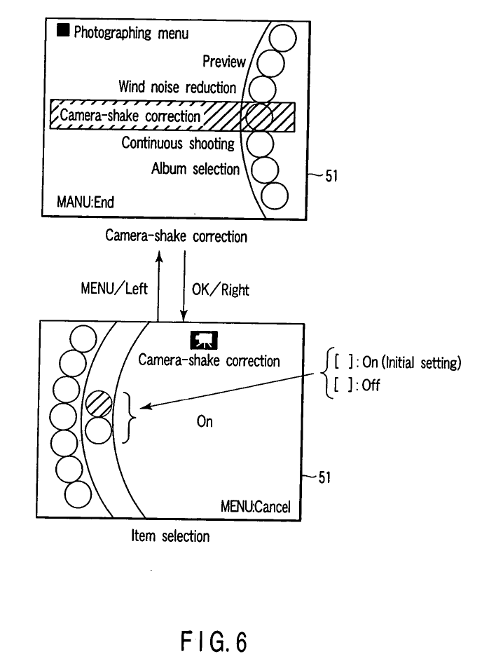

For example, assume that the menu screen is set in a state shown in the upper portion of FIG. 6. That is, on the menu screen, a plurality of selection candidates such as preview, wind noise reduction, camera-shake correction, continuous shooting, and album selection are displayed as icons on the arc. Also, assume that on the menu screen, only camera-shake correction is identified and displayed by the cursor or the like as a selection target of the plurality of selection candidates.

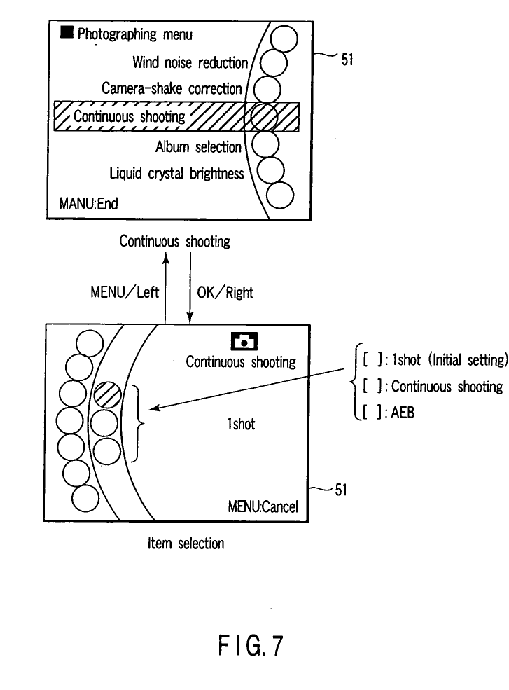

When the jog dial 7 is rotated n° clockwise in the menu screen display state shown in the upper portion of FIG. 6, the state changes to that shown in the upper portion of FIG. 7. That is, on the menu screen shown in the upper portion of FIG. 7, the plurality of selection candidates such as wind noise reduction, camera-shake correction, continuous shooting, album selection, and liquid crystal display brightness are displayed as icons, and aligned and displayed on the arc. On the menu screen, only continuous shooting is identified and displayed by the cursor or the like as a selection target of the plurality of selection candidates.

As shown in the upper portions of FIGS. 6 and 7, upon rotation of the jog dial 7, the CPU 114 excludes the selection candidate (preview) displayed at one end of the arc (e.g., at the upper end of the arc) from the display targets, and additionally displays a new selection candidate (liquid crystal display brightness) at the other end of the arc (e.g., at the lower end of the arc).

For example, assume that the total number of icons of the selection candidates is 24, and seven icons out of the 24 icons are displayed at equal intervals on the menu screen. When the icons are rotated in synchronism with the display on the menu screen, if the jog dial 7 is rotated 15° (360/24), the icon of the next selection candidate can be displayed as a selection target (identified and displayed by the cursor or the like). As described above, when the icons are rotated in synchronism with the display on the menu screen, manipulability and operability are improved.

Note that in response to the operations of the jog dial 7 and the determination button 8, the relationship between the rotational amount of the jog dial 7 and the transition amount of the identification display target can be arbitrarily set. For example, the user may feel that the rotational speed of the selection candidates is higher or lower than desired with respect to rotation of the jog dial 7. He or she may uniquely feel a sense of incompatibility when the rotation radius of the jog dial 7 is different from that of the arc on which the selection candidates are aligned. To cope with this, the relationship between these two rotational speeds can be arbitrarily set by the user. The user can rotate the jog dial 7, select an icon for setting a rotational speed relationship on the menu screen of the LCD 51, and set a preferable speed. The CPU 114 stores the set rotational speed relationship, and controls the rotational speed of the icons on the menu, on the basis of the relationship between the actual rotational speed of the jog dial 7 and the stored rotational speed. As described above, the relationship between these two rotational speeds can be arbitrarily set by the user, thereby further improving operability.

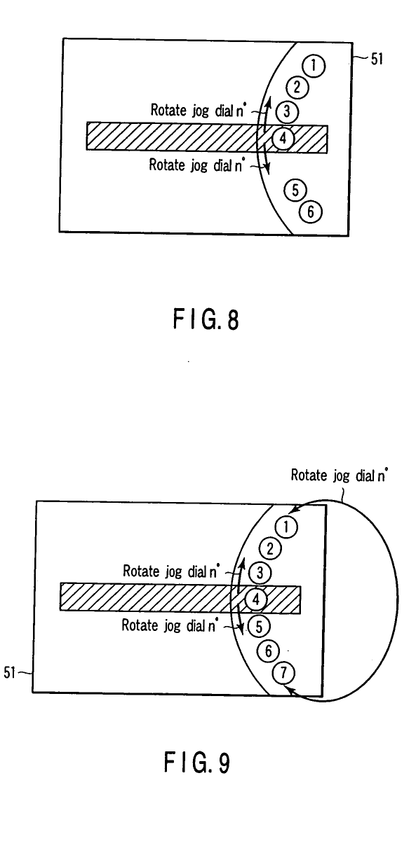

As shown in FIGS. 6, 7 and 8, in accordance with the predetermined rotational angle and rotational direction of the jog dial 7, the CPU 114 causes the selection target to change from one selection candidate to the next. For example, as shown in FIG. 8, assume that the LCD 51 displays a set of selection candidates (candidates 1 to 6) displayed at predetermined intervals along the arc, and some selection candidates (selection candidates 4 and 5) of the plurality of selection candidates are displayed at an interval different from the predetermined intervals. In this case, the CPU 114 also causes the selection target to change from one selection candidate to the next, in accordance with a predetermined rotational angle and rotational direction of the jog dial 7, and despite the different interval between certain candidates.

That is, when the jog dial 7 is rotated n° in the clockwise direction, the selection candidate 2 is selected after the selection candidate 1. Similarly, when the jog dial 7 is rotated n° clockwise, the selection candidate 3 is selected after the selection candidate 2. Similarly, when the jog dial 7 is rotated n° clockwise, the selection candidate 4 is selected after the selection candidate 3. Similarly, when the jog dial 7 is rotated n° clockwise, the selection candidate 5 is selected after the selection candidate 4. Even if a large interval is set between the selection candidates (selection candidates 4 and 5) with different categories to increase the visibility, the rotational angle of the jog dial 7 can be constant (n°) for the next selection candidate (the selection candidate 5 after the selection candidate 4) to be selected.

As shown in FIG. 9 assume that the total number of icons of the selection candidates is 7, and these seven icons are displayed at equal intervals on the menu screen. In this case, upon rotation of the jog dial 7, the CPU 114 excludes the selection candidate (e.g., the selection candidate 1) displayed at one end of the arc (e.g., at the upper end of the arc), and additionally displays the excluded selection candidate (e.g., the selection candidate 1) at the other end of the arc (e.g., at the lower end of the arc).

On the menu screen shown in the upper portion of FIG. 6 (camera-shake correction selection screen), upon pressing the determination key 81 or RIGHT key 84 of the determination button 8, the selection target (camera-shake correction) identified and displayed by the cursor or the like is selected. With this operation, the menu screen shown in the lower portion of FIG. 6 (item selection screen) is displayed. That is, the LCD 51 displays a plurality of selection sub-candidates (camera-shake correction ON and camera-shake correction OFF) which belong to the selection target (camera-shake correction) identified and displayed by the cursor or the like, along the arc having a first radial distance which is arranged concentrically with the above-described arc having a second radial distance. The first radial distance is different from the second radial distance. In addition, the LCD 51 identifies and displays the selection target of the plurality of selection sub-candidates by the cursor or the like. In the lower portion of FIG. 6, the second radial distance is greater than the first radial distance. As the jog dial 7 is rotated, the CPU 114 controls the change of the selection target by the cursor or the like along the arc on which the plurality of selection sub-candidates are aligned. Note that on the item selection screen shown in the lower portion of FIG. 6, upon pressing the menu button 9 or the LEFT key 85 of the determination button 8, the menu screen (camera-shake correction selection screen) shown in the upper portion of FIG. 6 is displayed.

On the menu screen shown in the upper portion of FIG. 7 (continuous shooting selection screen), upon pressing the determination key 81 or RIGHT key 84 of the determination button 8, the selection target (continuous shooting) identified and displayed by the cursor or the like is selected. With this operation, the menu screen shown in the lower portion of FIG. 7 (item selection screen) is displayed. That is, the LCD 51 displays a plurality of selection sub-candidates (one shot, continuous shooting, and AEB) which belong to the selection target (continuous shooting) identified and displayed by the cursor or the like, along the arc having a first radial distance which is arranged concentrically with the above-described arc having a second radial distance. The first radial distance is different from the second radial distance. In addition, the LCD 51 identifies and displays the selection target of the plurality of selection sub-candidates by the cursor or the like. In the lower portion of FIG. 7, the second radial distance is greater than the first radial distance. As the jog dial 7 is rotated, the CPU 114 controls the change of the selection target by the cursor or the like along the arc on which the plurality of selection sub-candidates are aligned. Note that on the item selection screen shown in the lower portion of FIG. 7, upon pressing the menu button 9 or the LEFT key 85 of the determination button 8, the menu screen (continuous shooting selection screen) shown in the upper portion of FIG. 7 is displayed.

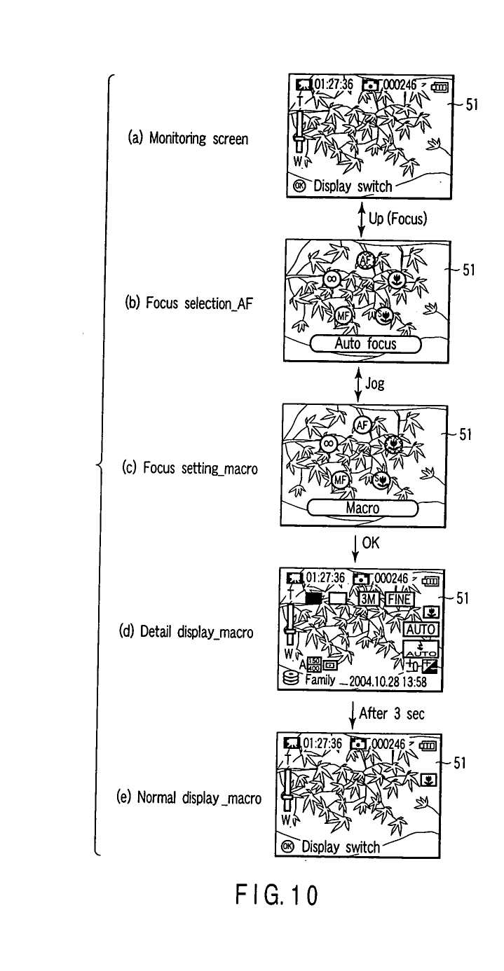

Next, with reference to FIG. 10, cyclic display of the selection candidates will be described.

After the photographic mode is started (while photographing a moving image), by pressing the moving image recording button 6 display (a) in FIG. 10 appears when the UP key 82 of the determination button 8 (first condition) is pressed, the LCD 51 displays the photographed video, and overlays a quick menu (focus selection) on the photographed video (as shown in display (b) of FIG. 10). That is, the CPU 114 aligns and displays a plurality of semitransparent selection candidates in a ring, and then identifies and displays the selection target by the cursor or the like. As described above, since the plurality of selection candidates are aligned and displayed in a ring, the display can visually notify the user that the plurality of selection candidates can be selected by the jog dial 7. In addition to this, since the display angle of the display unit 5 can be adjusted, the display surface of the plurality of displayed selection candidates and the surface of the jog dial 7 can be parallel. Upon rotation of the jog dial 7, the CPU 114 controls the change of the selection target by the cursor or the like, along the ring on which the plurality of selection candidates are aligned (e.g., display (b) of FIG. 10 to display (c) of FIG. 10). For example, upon pressing the determination key 81 of the determination button 8 on the screen shown in display (c) of FIG. 10 (focus selection_macro), the screen in display (d) of FIG. 10 (detail display_macro) is shown. Without any button operation, after 3 sec, the screen returns to display (e) of FIG. 10 (normal display_macro).

Note that upon pressing the menu button 9 after the photographic mode is stopped by pressing the moving image recording button 6 (second condition), the LCD 51 displays the menu screen as shown in the upper portion of FIG. 6 or the upper portion of FIG. 7.

As described above, the video photographic device displays the selection candidates aligned on a ring or arc. The video photographic device displays the selection candidates on the arc when a large number of selection candidates are used, or displays the selection candidates on the ring when a small number of selection candidates are used. When a large number of selection candidates are used, it is difficult to recognize the selection candidates if all the selection candidates are simultaneously displayed on the screen. Hence, some of the selection candidates are displayed on the arc. When a small number of selection candidates are used, all the selection candidates are displayed on the ring in order to simultaneously recognize all the selection candidates.

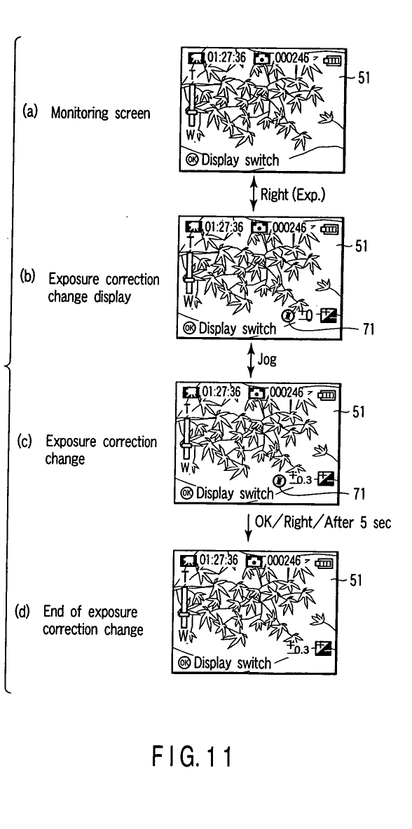

Next, with reference to FIG. 11, a setting change display which is adjustable using the jog dial will be described.

After the photographic mode is started (while photographing a moving image), by pressing the moving image recording button 6, display (a) in FIG. 11 appears. When the RIGHT key 84 of the determination button 8 is pressed, the LCD 51 displays the photographed video, and overlays exposure correction information on the photographed video (display (b) of FIG. 11). That is, the LCD 51 displays the current setting (current exposure correction setting) on the photographed video, and indicates that this setting can be changed by rotation of the jog dial 7. That is, the LCD 51 displays the icon 71 of the jog dial 7 at the position corresponding to the setting display. As a result, the user can be visually notified that the setting can be changed by rotation of the jog dial 7.

On the basis of rotation of the jog dial 7, the CPU 114 changes the exposure correction (display (c) of FIG. 11). Upon pressing the determination key 81 or RIGHT key 84 of the determination button 8, or upon the lapse of 5 sec without any button operation, the display changes to the original screen (display (d) of FIG. 11).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital camera comprising:
a photographic unit configured to photograph a video;
a recording unit configured to record the video photographed by the photographic unit;
a display unit configured to display the video photographed by the photographic unit, align and display a plurality of selection candidates on an arc in response to a display switching operation, and identify and display a selection target of the plurality of selection candidates;
a rotary member arranged substantially concentrically with the arc; and
an identification display control unit configured to control a change of the selection target among the plurality of selection candidates aligned on the arc on the basis of rotation of the rotary member.

2. A digital camera comprising:
a photographic unit configured to photograph a video;
a recording unit configured to record the video photographed by the photographic unit;
a display unit configured to display the video photographed by the photographic unit, align and display a plurality of selection candidates on a ring in response to a display switching operation, and identify and display a selection target of the plurality of selection candidates;
a rotary member arranged on a surface which is parallel to at least one position of a display surface of the plurality of selection candidates displayed on the ring; and
an identification display control unit configured to control a change of the selection target along the plurality of selection candidates aligned on the ring on the basis of rotation of the rotary member.

3. A digital camera comprising:
a photographic unit configured to photograph a video;
a recording unit configured to record the video photographed by the photographic unit;
a rotary member;
a display unit configured to display the video photographed by the photographing unit, display a setting in response to a display switching operation, and indicate that the setting can be changed by rotation of the rotary member; and
a setting change control unit configured to change the setting on the basis of rotation of the rotary member.

4. An electronic device comprising:
a display unit configured to align and display a plurality of selection candidates on an arc, and identify and display a selection target of the plurality of selection candidates;
a rotary member arranged substantially concentrically with the arc; and
an identification display control unit configured to control a change of the selection target among the plurality of selection candidates aligned on the arc on the basis of rotation of the rotary member.

5. A device according to claim 4, wherein the identification display control unit controls the transition of the identification display target in synchronism with rotation of the rotary member.

6. A device according to claim 4, further comprising a setting unit configured to set a correspondence relationship between a rotational amount of the rotary member and a transition amount of the identification display target.

7. A device according to claim 4, wherein the identification display control unit changes the selection target in accordance with a predetermined rotational angle and a rotational direction of the rotary member.

8. A device according to claim 4, wherein
the display unit displays some of the plurality of selection candidates on the arc at predetermined intervals, and displays other selection candidates of the plurality of selection candidates at intervals different from the predetermined intervals, and
the identification display control unit changes the selection target in accordance with a predetermined rotational angle and a rotational direction of the rotary member.

9. A device according to claim 4, wherein
the display unit aligns and displays some of the selection candidates on the arc, and
the identification display control unit excludes, upon rotation of the rotary member, a selection candidate displayed at one end of the arc, and additionally displays a new selection candidate at the other end of the arc.

10. A device according to claim 4, wherein
the display unit displays a plurality of selection sub-candidates which belong to the identified selection target, along a second arc which is concentric with the arc and has a radial distance different from a radial distance of the arc, and identifies and displays a selection target of the plurality of selection sub-candidates, and
the identification display control unit controls the change of the selection target along the second arc, on the basis of rotation of the rotary member.

11. A device according to claim 4, which further comprises a main body including a housing unit which houses the display unit, the rotary member, and the identification display control unit, and in which
the display unit is configured to be housed in the housing unit, and when the display unit is housed in the housing, the display unit is configured not to have a concentric relationship between the arc and the rotary member.

12. An electronic device comprising:
a display unit configured to align and display a plurality of selection candidates on a ring, and identify and display a selection target of the plurality of selection candidates;
a rotary member arranged on a surface which is parallel to a display surface of the plurality of selection candidates displayed on the ring; and
an identification display control unit configured to control a change of the selection target among the plurality of selection candidates aligned on the ring on the basis of rotation of the rotary member.

13. A device according to claim 12, wherein
on the basis of a first condition, the display unit aligns and displays the plurality of selection candidates on the ring and identifies and displays the selection target of the plurality of selection candidates, and, on the basis of a second condition, the display unit aligns and displays the plurality of selection candidates on the arc, and identifies and displays a selection target of the plurality of selection candidates,
the rotary member is arranged substantially concentrically with the arc, and
the identification display control unit controls a change of the selection target along the plurality of selection candidates aligned on the ring and the arc on the basis of rotation of the rotary member.

14. A digital camera according to claim 1, which further comprises
a record designation unit configured to designate a start and stop of a photographic mode,
a first menu designation unit configured to designate a display of a first menu screen, and
a second menu designation unit configured to designate a display of a second menu screen, and in which
the display unit displays a photographed video, aligns and displays the plurality of selection candidates on the ring on the photographed video, identifies and displays the selection target in accordance with the display on the first menu screen by the first menu designation unit after starting the photographic mode by the record designation unit, aligns and displays the plurality of selection candidates on the arc, and identifies and displays the selection target in accordance with the display on the second menu screen by the second menu designation unit after stopping the photographic mode by the record designation unit.

15. A device according to claim 14, wherein the display unit displays the photographed video, and aligns and displays the plurality of semitransparent selection candidates on the ring on the photographed video in accordance with the display on the first menu screen by the first menu designation unit after starting the photographic mode by the record designation unit.

16. A device according to claim 13, wherein
depending on the number of the selection candidates, the display unit selectively switches between a first display mode in which all the plurality of selection candidates are aligned and displayed on the ring and a second display mode in which a predetermined number of selection candidates are aligned and displayed on the arc,
the first display mode identifies and displays one of the plurality of selection candidates aligned on the ring upon rotation of the rotary member, and
upon rotation of the rotary member, the second display mode excludes a selection candidate displayed at one end of the arc, additionally displays a new selection candidate at the other end of the arc, and identifies and displays one of the predetermined number of selection candidates aligned on the arc as the selection target.

17. An electronic device comprising:
a rotary member;
a display unit configured to display a setting, and indicate that the setting can be changed by rotation of the rotary member; and
a setting change control unit configured to change the setting upon rotation of the rotary member.

18. A device according to claim 17, wherein the display unit displays an image of the rotary member at a position corresponding to the display of the setting.
